(19) United States
(12) Patent Application Publication
(10) Pub. No.: US 2026/0063172 A1
(43) Pub. Date: Mar. 5, 2026

(54) VEHICLE WHEEL BEARING HAVING SEALING MEMBER OF IMPROVED STRUCTURE

(71) Applicant: ILJIN GLOBAL CO., LTD., Seoul (KR)

(72) Inventors: Myoung Jin LEE, Seoul (KR); Nam Gyu HA, Seoul (KR)

(73) Assignee: ILJIN GLOBAL Co.,Ltd, Seoul (KR)

(21) Appl. No.: 19/156,638

(22) PCT Filed: Feb. 14, 2024
(86) PCT No.: PCT/KR2024/002113

§ 371 Date: Nov. 11, 2025

(30) Foreign Application Priority Data
Feb. 14, 2023 (KR) 10-2023-0019675

(51) Int. Cl. F16C 33/78; F16J 15/3232

(52) U.S. Cl. CPC F16C 33/7823; F16C 33/7886; F16J 15/3232; F16C 2326/02

(57) ABSTRACT

A vehicular wheel bearing includes a rotating element that rotates together with the vehicular wheel; a non-rotating element mounted and fixed to the vehicle body; a plurality of rolling elements provided between the rotating element and the non-rotating element; and a sealing member mounted between the rotating element and the non-rotating element to prevent inflow of external foreign matters. The sealing member includes a first member mounted to one of the rotating element and the non-rotating element of the wheel bearing; and a second member mounted to the other of the rotating element and the non-rotating element of the wheel bearing. The first member of the sealing member includes a first frame and an elastic sealing portion attached to the first frame, and the second member of the sealing member includes a second frame and an elastic member attached to the second frame.

### CROSS-REFERENCE TO RELATED APPLICATIONS

This application is a national phase of International Application No. PCT/KR2024/002113 filed on Feb. 14, 2024, which claims priority to Korean Patent Application No. 10-2023-0019675 filed on Feb. 14, 2023, the entire contents of which are herein incorporated by reference.

### TECHNICAL FIELD

The present disclosure relates to a vehicular wheel bearing for rotatably mounting and supporting a vehicular wheel to a vehicle body, more particularly to a vehicular wheel bearing comprising an improved sealing member configured to suppress an increase in drag torque caused by a contact-type sealing lip(s) while maintaining a stable sealing function through the contact-type sealing lip(s).

### BACKGROUND ART

A wheel bearing is a device used for rotatably mounting and supporting a vehicular wheel to a vehicle body, and performs a function of connecting a rotating element, to which a vehicular wheel is mounted, to a non-rotating element fixed to a vehicle body through rolling elements such that the vehicular wheel is rotatably mounted and supported to the vehicle body.

On the other hand, since wheel bearings are easily exposed to external foreign substances such as mud, moisture, or the like due to the nature of products used by being mounted to the wheels of a vehicle, the wheel bearings have a sealing member which prevents external foreign substances from entering the insides of the wheel bearings.

Referring to FIG. 1, a structure of a vehicular wheel bearing comprising a sealing member is exemplarily shown. As shown in FIG. 1, a vehicular wheel bearing 10 may be configured such that a rotating element (e.g., a wheel hub 20 and an inner ring 30) rotating together with a vehicular wheel is rotatably mounted to a non-rotating element (e.g., an outer ring 40) fixed to a vehicle body through rolling elements 50. A sealing member 60 may be provided between the rotating element and the non-rotating element of the wheel bearing to prevent inflow of external foreign matters or leakage of internal lubricant (grease).

Referring to FIG. 2, a sealing member 60 which may be used in a vehicular wheel bearing 10 (for example, an inboard-side sealing member shown in part A of FIG. 1) is exemplarily shown.

As shown in FIG. 2, the sealing member 60 may comprise an outer portion 70 positioned radially outward and an inner portion 80 positioned radially inward. At least one of the outer portion 70 and the inner portion 80 may be provided with an elastic sealing portion 90. At least one sealing lip 92 provided in the elastic sealing portion 90 may be arranged to contact or to be adjacent to a counterpart member, thereby performing a sealing function.

However, in such a sealing member 60, in order to more reliably prevent inflow of foreign matters, it is advantageous to form the sealing member 60 to have a greater number of contact-type sealing lips, or to have thicker contact-type sealing lips. However, in such cases, there may arise a problem that drag torque increases by the contact-type sealing lips during vehicle operation, which in turn reduces the driving efficiency of the vehicle.

### DISCLOSURE

### Technical Problem

The present disclosure is for the purpose of resolving the above-described matters with a vehicular wheel bearing, and the present disclosure is for the purpose of providing a vehicular wheel bearing comprising an improved sealing member configured to suppress an increase in drag torque caused by a contact-type sealing lip(s) while maintaining a stable sealing function through the contact-type sealing lip(s).

### Technical Solution

Representative configurations of the present disclosure to achieve the above aspects are as follows.

According to one embodiment of the present disclosure, there is provided a vehicular wheel bearing for rotatably mounting and supporting a vehicular wheel to a vehicle body. The vehicular wheel bearing according to one embodiment of the present disclosure may comprise: a rotating element that rotates together with the vehicular wheel; a non-rotating element mounted and fixed to the vehicle body; a plurality of rolling elements provided between the rotating element and the non-rotating element; and a sealing member mounted between the rotating element and the non-rotating element to prevent inflow of external foreign matters. According to one embodiment of the present disclosure, the sealing member may comprise: a first member mounted to one of the rotating element and the non-rotating element of the wheel bearing; and a second member mounted to the other of the rotating element and the non-rotating element of the wheel bearing. According to one embodiment of the present disclosure, the first member of the sealing member may comprise a first frame and an elastic sealing portion attached to the first frame, and the second member of the sealing member may comprise a second frame and an elastic member attached to the second frame. According to one embodiment of the present disclosure, the elastic sealing portion may comprise at least one sealing lip of contacting with the second member of the sealing member to perform sealing, and the second member may be provided with an uneven portion on all or part of a region contacted by the sealing lip.

According to one embodiment of the present disclosure, an adhesive layer may be provided with on a surface of the second frame of the second member, and the elastic member may be configured to be attached and formed on the adhesive layer.

According to one embodiment of the present disclosure, the uneven portion may be configured to be formed on the adhesive layer.

According to one embodiment of the present disclosure, the first frame may comprise a press-fit portion and a flange portion bent and extended from the press-fit portion, the second frame may comprise a press-fit portion and a flange portion bent and extended from the press-fit portion, and the uneven portion may be configured to be formed on the adhesive layer located on the flange portion of the second frame.

According to one embodiment of the present disclosure, the elastic member may be an encoder used to measure a rotational speed of the wheel bearing.

According to one embodiment of the present disclosure, the elastic member may be provided on a first axial end surface of the flange portion of the second frame, and the uneven portion may be provided on a second axial end surface located on the opposite side of the first axial end surface of the flange portion.

According to one embodiment of the present disclosure, the elastic member may be formed through vulcanization using a mold.

According to one embodiment of the present disclosure, the uneven portion may be configured to be formed for vulcanization of the elastic member.

According to one embodiment of the present disclosure, the uneven portion may be configured to be formed by a corresponding uneven portion provided on the mold during vulcanization of the elastic member.

According to one embodiment of the present disclosure, the corresponding uneven portion of the mold may be formed through shot blast process.

According to one embodiment of the present disclosure, the sealing member may be an inboard-side sealing member that seals a vehicle body-side end portion of the wheel bearing.

Further, the vehicular wheel bearing according to the present disclosure may further comprise other additional configurations without departing from the technical sprit of the present disclosure.

### Advantageous Effects

The vehicular wheel bearing according to one embodiment of the present disclosure is configured such that an uneven portion is provided on a surface contacting with a sealing lip(s). As a result, the contact area of the sealing lip(s) may be reduced by the uneven portion, and the frictional resistance of the sealing lip(s) may be reduced by grease accommodated in the uneven portion. Thus, the problem of increased drag torque caused by the contact-type sealing lip(s) and the consequent reduction in driving efficiency of the vehicle can be suppressed.

Furthermore, the vehicular wheel bearing according to one embodiment of the present disclosure is configured such that the above uneven portion is formed on the adhesive layer applied to the frame of the sealing member. Accordingly, due to the viscosity of the adhesive layer, grease accommodated in the uneven portion can be retained more stably in the uneven portion. As a result, drag torque caused by the contact-type sealing lip(s) can be further reduced.

### BRIEF DESCRIPTION OF DRAWINGS

FIG. 1 exemplarily shows a structure of a conventional vehicular wheel bearing.

FIG. 2 exemplarily shows a structure of a sealing member widely used in vehicular wheel bearings (e.g., a sealing member of a pack seal structure as shown in portion A of FIG. 1).

FIG. 3 exemplarily shows a structure of a vehicular wheel bearing according to one embodiment of the present disclosure.

FIG. 4 exemplarily shows a structure of an inboard-side sealing member of the vehicular wheel bearing shown in FIG. 3.

FIG. 5 schematically shows a method of forming an uneven portion on a sealing lip contact region according to one embodiment of the present disclosure.

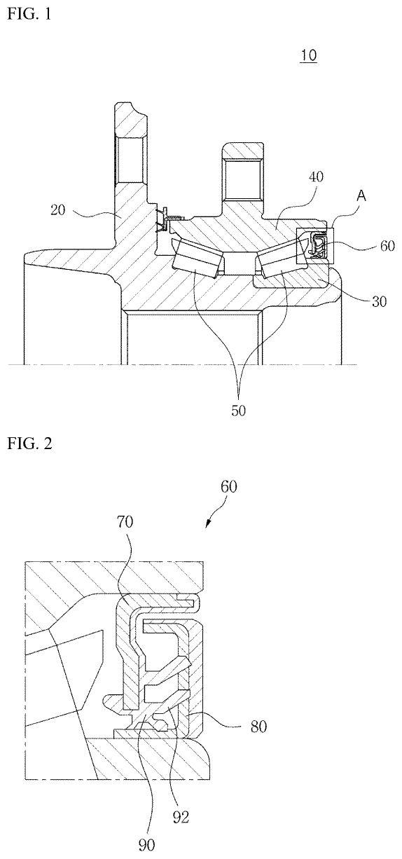

### EXPLANATION OF REFERENCE NUMERALS

100: Vehicular wheel bearing
200: Rotating element
210: Wheel hub
220: Inner ring
300: Non-rotating element
310: Vehicle-side mounting flange
400: Rolling element
500: Sealing member
600: First member (of sealing member)
610: First frame
620: Elastic sealing portion
630: Sealing lip
700: Second member (of sealing member)
710: Second frame
720: Elastic member (e.g., encoder)
730: Adhesive layer
740: Uneven portion
800: Mold
810: Corresponding uneven portion

### DETAILED DESCRIPTION

Example embodiments of the present disclosure are exemplified for the purpose of describing the technical spirit of the present disclosure. The scope of the claims according to the present disclosure is not limited to the example embodiments described below or to the detailed descriptions of these example embodiments.

Unless otherwise defined, all technical and scientific terms used herein have the same meaning commonly understood by those skilled in the art to which the present disclosure pertains. All terms used herein are selected for the purpose of more clearly describing the present disclosure and not limiting the scope of the present disclosure defined by appended claims.

Unless the phrase or sentence clearly indicates otherwise, terms “comprising” “including” “having” and the like used herein should be construed as open-ended terms encompassing the possibility of including other example embodiments.

The term “axial direction” used herein may be defined as a direction extending along a rotational central axis of a wheel bearing (the term “axially inward” refers to a direction toward the vehicle body and the term “axially outward” refers to a direction toward the wheel), the term “radial direction” used herein may be defined as a direction perpendicular to the axial direction and away from the rotational central axis or approaching the rotational central axis. The term “circumferential direction” used herein may be defined as a direction rotating about the axial direction described above.

Unless the phrase or sentence clearly indicates otherwise, the expression “a constituent element extends in the axial direction or the radial direction” used herein should be understood as encompassing a case where the constituent element extends parallel to the axial direction or the radial direction as well as a case where the constituent element extends obliquely with respect to the axial direction or the radial direction.

The singular form described herein may include the plural form unless the context clearly dictates otherwise, and this is equally applied to the singular form set forth in the claims.

Throughout the present specification, when a constituent element is referred to as being “positioned” at or “formed” on one side of another constituent element, the constituent element may be in direct contact with or directly formed on the one side of another constituent element, or may be positioned at or formed on another constituent element by intervening yet another constituent element therebetween.

Hereinafter, example embodiments of the present disclosure will be described in detail with reference to the accompanying drawings at such an extent that they may be readily practiced by those ordinary skilled in the art. In the accompanying drawings, the same reference numerals are assigned to the same or corresponding components. Further, in the following descriptions of the example embodiments, duplicate description(s) of the same or corresponding constituent elements may be omitted. However, even though a description(s) of any constituent element is omitted, such a constituent element is not intended to be excluded in any example embodiment.

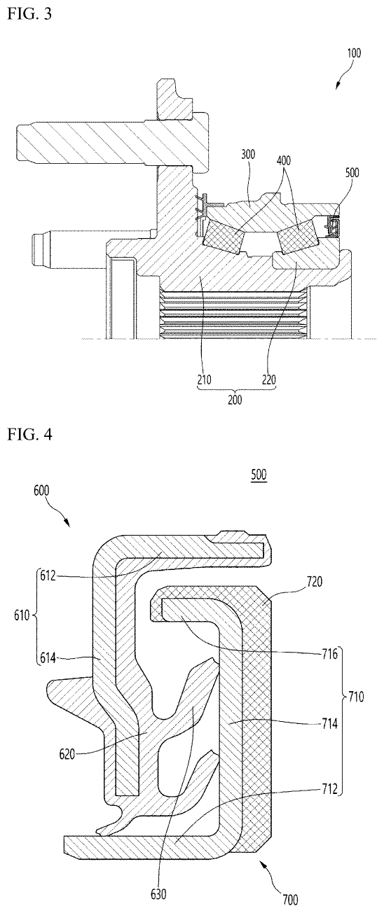

Referring to FIGS. 3 to 5, a vehicular wheel bearing according to one embodiment of the present disclosure and a sealing member which may be applied to such a vehicular wheel bearing are exemplarily shown.

As shown in the drawings, a vehicular wheel bearing 100 according to one embodiment of the present disclosure may be formed with a structure generally similar to that of a conventional vehicular wheel bearing.

According to one embodiment of the present disclosure, a wheel bearing assembly 100 may be configured such that a rotating element 200 (e.g., a wheel hub 210 and an inner ring 220) that rotates together with a vehicle wheel is connected to a non-rotating element 300 (e.g., an outer ring) fixedly coupled to a vehicle body component through rolling elements 400, thereby rotatably supporting the vehicle wheel relative to the vehicle body.

According to one embodiment of the present disclosure, the wheel hub 210 which constitutes the rotating element 200 may be formed in a substantially cylindrical shape extending in the axial direction, and a wheel mounting flange (hub flange) may be provided on the outer circumferential surface of the wheel hub 210. The wheel mounting flange may be formed in a shape extending radially outward from the outer circumferential surface of the wheel hub 210 and may be used for mounting a vehicle wheel to the wheel hub 210 using hub bolts or the like. Meanwhile, the inner ring 220 may be mounted to the vehicle-body-side end portion of the wheel hub 210, and a raceway (inner raceway) may be formed on a portion of the outer circumferential surface of the wheel hub 210 to support the rolling elements 400 from the radially inward.

According to one embodiment of the present disclosure, at least one the inner ring 220 may be mounted on the outer circumferential surface of the wheel hub 210, and a raceway (inner raceway) for the rolling elements may be formed on an outer circumferential surface of the inner ring 220 to support the rolling elements 400 from the radially inward. For example, the inner ring 220 may be configured to be press-fitted to a seating portion provided on the vehicle-body-side end portion of the wheel hub 210, and may be configured to be supported/fixed on the wheel hub 210 by plastically deforming the vehicle-body-side end portion of the wheel hub 210 radially outward as shown in FIG. 3 or by fastening a nut to the vehicle-body-side end portion of the wheel hub 210.

According to one embodiment of the present disclosure, the outer ring constituting the non-rotating element 300 may comprise a vehicle-body-side mounting flange for mounting the wheel bearing to the vehicle body on its outer circumferential surface, and may comprise a raceway (outer raceway) contacted by the rolling elements 400 on its inner circumferential surface. The raceway (outer raceway) formed on the inner circumferential surface of the outer ring may cooperate with the raceway (inner raceway) formed on the wheel hub 210 and/or the inner ring 220 to accommodate and support the rolling elements 400, which are rolling bodies, between the raceways.

According to one embodiment of the present disclosure, the rolling elements 400 may be disposed between the rotating element 200 and the non-rotating element 300 of the wheel bearing 100, and may perform a function of rotatably supporting the rotating element 200 relative to the non-rotating element 300.

In the embodiment shown in the drawings, the wheel bearing is configured such that one raceway for supporting the rolling elements is directly formed on a portion of the outer circumferential surface of the wheel hub. However, a wheel bearing according to one embodiment of the present disclosure is not limited to such a structure, and may alternatively be modified and implemented in other structures, such as a structure where two inner rings are mounted to the wheel hub and the rolling elements are supported by the two inner rings.

According to one embodiment of the present disclosure, a sealing member 500 may be provided at one or both ends of the wheel bearing 100 to prevent external foreign matters from entering into the bearing space or to prevent lubricant (grease) filled in the bearing space from leaking to the outside.

Referring to FIG. 4, the structure of a sealing member (in the embodiment shown in the drawings, an inboard-side sealing member) that may be used in the vehicular wheel bearing 100 according to one embodiment of the present disclosure is exemplarily shown.

According to one embodiment of the present disclosure, the sealing member 500 may comprise: a first member 600 mounted to one of the rotating element 200 and the non-rotating element 300 of the wheel bearing 100; and a second member 700 mounted to the other of the rotating element 200 and the non-rotating element 300 of the wheel bearing 100.

For example, in the embodiment shown in the drawings, the first member 600 of the sealing member 500 is configured to be press-fitted and mounted on the outer ring constituting the non-rotating element 300; and the second member 700 of the sealing member 500 is configured to be press-fitted and mounted on the inner ring 220 constituting the rotating element 200.

According to one embodiment of the present disclosure, the first member 600 of the sealing member 500 may comprise a frame 610 (first frame) of forming a body; and an elastic sealing portion 620 attached to the first frame 610.

According to one embodiment of the present disclosure, the first frame 610 may comprise a press-fit portion 612 having a substantially cylindrical structure, and a flange portion 614 bent and extended from the press-fit portion 612 (e.g., formed to extend in the radial direction).

According to one embodiment of the present disclosure, the press-fit portion 612 of the first frame 610 may be configured to be press-fitted to one of the rotating element 200 and the non-rotating element 300 of the wheel bearing 100.

For example, in the embodiment shown in the drawings, the press-fit portion 612 of the first frame 610 is configured to be press-fitted to the inner circumferential surface of the outer ring functioning as the non-rotating element 300 of the wheel bearing 100.

According to one embodiment of the present disclosure, the elastic sealing portion 620 may be formed of an elastic material such as rubber, and may be formed to be integrally attached to the first frame 610 by a process such as vulcanization.

According to one embodiment of the present disclosure, an adhesive layer may be formed on the first frame 610 and then the elastic sealing portion 620 may be formed to be integrally attached on adhesive layer.

For example, the adhesive layer may be formed by immersing the first frame 610 in an adhesive solution and then drying it. Further, the elastic sealing portion 620 may be formed by placing the first frame 610, on which the adhesive layer is formed, into a mold, injecting a rubber material into the mold, and then applying heat and pressure so that the elastic sealing portion 620 is integrally attached to the first frame 610.

According to one embodiment of the present disclosure, the elastic sealing portion 620 may comprise at least one sealing lip 630 (contact-type sealing lip) of contacting with the second member 700 of the sealing member 500 to perform sealing.

According to one embodiment of the present disclosure, the sealing lip 630 may be a side lip of contacting with the flange portion of the second member 700 to perform sealing.

According to one embodiment of the present disclosure, the second member 700 of the sealing member 500 may comprise a frame 710 (second frame) and an elastic member 720 attached to the second frame 710.

According to one embodiment of the present disclosure, the second frame 710 may be a portion forming the basic body of the second member 700 of the sealing member 500, and may be configured to be press-fitted and mounted on one of the rotating element or non-rotating element of the wheel bearing.

According to one embodiment of the present disclosure, the second frame 710 may comprise a press-fit portion 712 having a substantially cylindrical structure; and a flange portion 714 bent and extended from the press-fit portion 712 (e.g., formed to extend in the radial direction).

According to one embodiment of the present disclosure, the press-fit portion 712 of the second frame 710 may be configured to be press-fitted to the other of the rotating element 200 and the non-rotating element 300 of the wheel bearing 100.

For example, in the embodiment shown in the drawings, the press-fit portion 712 of the second frame 710 is configured to be press-fitted and mounted on the outer circumferential surface of the inner ring 220 functioning as the rotating element 200 of the wheel bearing 100.

According to one embodiment of the present disclosure, the elastic member 720 may be formed using an elastic material such as rubber, and may be formed to be integrally attached to the second frame 710 by a process such as vulcanization, similar to the elastic sealing portion 620 of the first member 600.

According to one embodiment of the present disclosure, an adhesive layer 730 may be formed on the second frame 710 and then the elastic member 720 may be formed to be integrally attached on the adhesive layer 730.

For example, the adhesive layer 730 may be formed by immersing the second frame 710 in an adhesive solution to coat the surface of the second frame 710 with adhesive and then drying it. Further, the elastic member 720 may be formed by placing the second frame 710, on which the adhesive layer is formed, into a mold, injecting a rubber material into the mold, and then applying heat and pressure so that the elastic member 720 is integrally attached to the second frame 710.

That is, the second member 700 of the sealing member 500 according to one embodiment of the present disclosure may be formed to have a structure in which the adhesive layer 730 is formed entirely on the surface of the second frame 710 and then the elastic member 720 is integrally attached to one side portion of the second frame 710 through the adhesive layer 730.

According to one embodiment of the present disclosure, the elastic member 720 provided in the second member 700 of the sealing member 500 may be an encoder used to measure a rotational speed of the wheel bearing.

However, the elastic member 720 is not necessarily limited to being an encoder, and as long as it is a configuration in which the elastic member is integrally attached to the frame of the sealing member via the adhesive layer, it may be implemented in various alternative structures (e.g., an elastic sealing portion).

According to one embodiment of the present disclosure, the second member 700 of the sealing member 500 may be provided with an uneven portion 740 on all or part of a region contacted by the sealing lip 630 provided on the first member 600.

According to one embodiment of the present disclosure, the uneven portion 740 may be formed on a portion of the flange portion (the portion corresponding to the flange portion 714 of the second frame 710) of the second member 700, with which the sealing lip 630 contacts.

According to one embodiment of the present disclosure, the uneven portion 740 may be configured to be simultaneously formed with the elastic member 720, during forming the elastic member 720 by vulcanization.

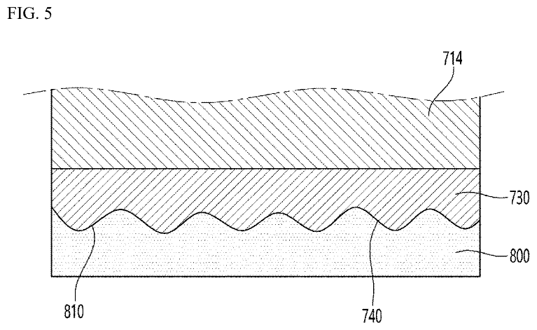

For example, when performing vulcanization by placing the second frame 710 coated with the adhesive layer 730 into a mold 800, injecting a rubber material into the mold 800, and applying heat and pressure, the rubber material flows into a cavity provided in the mold (not shown), thereby forming the elastic member 720. During this process, the adhesive layer 730 applied on the second frame 710 is pressed by a corresponding uneven portion 810 formed on one side of the mold 800, and thus the uneven portion 740 is formed on the adhesive layer 730. (See FIG. 5: For convenience of explanation, the thickness of the adhesive layer is illustrated in an enlarged manner in FIG. 5, while the adhesive layer is omitted in other drawings because the adhesive layer is formed with a very thin thickness on the frame.)

According to this method, since the uneven portion 740 can be formed simultaneously in the process of forming the elastic member 720 on the second frame 710 through vulcanization, it becomes possible to easily form the uneven portion 740 at the portion contacted by the sealing lip 630 without adding separate processes.

When the uneven portion 740 is formed on the portion of the second member 700 of the sealing member 500, with which the sealing lip 630 contacts, as described above, the contact area of the sealing lip 630 can be reduced due to the uneven portion 740, and the grease inserted into the uneven portion 740 can lubricate the contact region of the sealing lip 630. As a result, the drag torque generated by the contact of the sealing lip 630 can be reduced.

Moreover, since the vehicular wheel bearing 100 according to one embodiment of the present disclosure is configured such that the adhesive layer 730 is coated on the surface of the second frame 710 and then the uneven portion 740 is formed on the adhesive layer 730, the grease inserted into the uneven portion 740 can be retained more stably in the uneven portion 740 due to the physical properties of the adhesive layer 730 having higher viscosity. As a result, the drag torque caused by the contact of the sealing lip 630 can be further reduced.

According to one embodiment of the present disclosure, the corresponding uneven portion 810 provided in the mold 800 may be formed in a shape corresponding to the uneven portion 740, and may be formed on one side surface of the mold 800 through a process such as shot blasting.

Although the present disclosure has been described above in terms of specific items such as detailed constituent elements as well as the limited example embodiments and the drawings, they are merely provided to help more general understanding of the present disclosure, and the present disclosure is not limited to the above example embodiments. Various modifications and changes could have been realized by those skilled in the art to which the present disclosure pertains from the above description.

Therefore, the spirit of the present disclosure need not to be limited to the above-described example embodiments, and in addition to the appended claims to be described below, and all ranges equivalent to or changed from these claims need to be the to belong to the scope and spirit of the present disclosure.

1. A vehicular wheel bearing (100) for rotatably mounting and supporting a vehicular wheel to a vehicle body, the vehicular wheel bearing comprising:
a rotating element (200) that rotates together with the vehicular wheel;
a non-rotating element (300) mounted and fixed to the vehicle body;
a plurality of rolling elements (400) provided between the rotating element (200) and the non-rotating element (300); and
a sealing member (500) mounted between the rotating element (200) and the non-rotating element (300) to prevent inflow of external foreign matters,
wherein the sealing member (500) comprises: a first member (600) mounted to one of the rotating element (200) and the non-rotating element (300) of the wheel bearing (100); and a second member (700) mounted to the other of the rotating element (200) and the non-rotating element (300) of the wheel bearing (100),
wherein the first member (600) of the sealing member (500) comprises a first frame (610) and an elastic sealing portion (620) attached to the first frame (610),
wherein the second member (700) of the sealing member (500) comprises a second frame (710) and an elastic member (720) attached to the second frame (710),
wherein the elastic sealing portion (620) comprises at least one sealing lip (630) of contacting with the second member (700) of the sealing member (500) to perform sealing, and
wherein the second member (700) is provided with an uneven portion (740) on all or part of a region contacted by the sealing lip (630).

2. The vehicular wheel bearing of claim 1, wherein an adhesive layer (730) is provided on a surface of the second frame (710) of the second member (700), and
wherein the elastic member (720) is configured to be attached and formed on the adhesive layer (730).

3. The vehicular wheel bearing of claim 2, wherein the uneven portion (740) is configured to be formed on the adhesive layer (730).

4. The vehicular wheel bearing of claim 3, wherein the first frame (610) comprises a press-fit portion (612) and a flange portion (614) bent and extended from the press-fit portion (612),
wherein the second frame (710) comprises a press-fit portion (712) and a flange portion (714) bent and extended from the press-fit portion (712), and
wherein the uneven portion (740) is configured to be formed on the adhesive layer (730) located on the flange portion (714) of the second frame (710).

5. The vehicular wheel bearing of claim 4, wherein the elastic member (720) is an encoder used to measure a rotational speed of the wheel bearing.

6. The vehicular wheel bearing of claim 5, wherein the elastic member (720) is provided on a first axial end surface of the flange portion (714) of the second frame (710), and
wherein the uneven portion (740) is provided on a second axial end surface located on the opposite side of the first axial end surface of the flange portion (714).

7. The vehicular wheel bearing of claim 6, wherein the elastic member (720) is formed by vulcanization using a mold (800).

8. The vehicular wheel bearing of claim 7, wherein the uneven portion (740) is configured to be formed during vulcanization of the elastic member (720).

9. The vehicular wheel bearing of claim 8, wherein the uneven portion (740) is configured to be formed by a corresponding uneven portion (810) provided on the mold (800) during vulcanization of the elastic member (720).

10. The vehicular wheel bearing of claim 9, wherein the corresponding uneven portion (810) of the mold (800) is formed through shot blast process.

11. The vehicular wheel bearing of claim 9, wherein the sealing member (500) is an inboard-side sealing member that seals a vehicle-body side end portion of the wheel bearing.
